(19) United States
(12) Patent Application Publication
(10) Pub. No.: US 2011/0217958 A1
(43) Pub. Date: Sep. 8, 2011

(54) SYSTEM AND METHOD FOR REPORTING CIVIC INCIDENTS OVER MOBILE DATA NETWORKS

(76) Inventor: Jason A. Kiesel, Los Angeles, CA (US)

(21) Appl. No.: 12/954,333

(22) Filed: Nov. 24, 2010

Related U.S. Application Data
(60) Provisional application No. 61/264,227, filed on Nov. 24, 2009.

(51) Int. Cl. H04W 4/00; H04W 64/00

(52) U.S. Cl. 455/414.1

(57) ABSTRACT

The system is a computer-implemented method for transmitting information, photos, video and other media about a civic infrastructure problem from a mobile device to a designated control entity. The control entity can then transmit data related to the infrastructure problem to mobile and other devices associated with the system that are within the geographic location of the infrastructure problem.

This patent application claims priority to U.S. Provisional Patent Application No. 61/264,227 filed on Nov. 24, 2009 and incorporated by reference herein in its entirety.

### BACKGROUND OF THE SYSTEM

The present system relates to the field of mobile applications and mobile devices, the method of transferring data and transferring contents related to the user reporting of civic incidents in specific geographic locations.

In the prior art, there is no good system for reporting civic incidents or civic infrastructure problems to the appropriate authorities. In current practice, if a citizen sees a civic infrastructure issue, the citizen needs to determine which civic entity to contact to report the situation. The citizen then needs to communicate the problem and the location to a menu driven system or to an operator on a telephone. Some communities may have special programs for certain infrastructure problems. For example, a community may have a “pothole hotline” for citizens to report road problems such as potholes. However, for other infrastructure issues, the citizen may not know which department or even which government (i.e. city, county, or state) may have jurisdiction over the infrastructure.

Even when the citizen finds the right resource for reporting a problem, the method of getting information from the citizen is slow and does not elicit the information needed to maximize the chances of quick repair or even efficient ranking of reports for repair. The citizen may not have the correct geographic location of the problem or the citizen may not accurately describe the problem in a way in which the severity of the problem can be gauged. Another disadvantage is that after reporting, there is no way for other citizens to be made aware of the problem, preventing the opportunity to avoid problem areas if desired.

### BRIEF SUMMARY OF THE SYSTEM

The system is a computer-implemented method for transmitting information, photos, video and other media about a civic infrastructure problem from a mobile device to a designated control entity. The control entity can then transmit data related to the infrastructure problem to mobile and other devices associated with the system that are within the geographic location of the infrastructure problem.

The system overcomes deficiencies in the prior art by providing a system, method, apparatus, and computer program product that provides a way to report civic maintenance and infrastructure issues through a mobile application on a wireless device and/or to other communication devices as determined by users that participate in the system.

The system also provides automated reporting of civic infrastructure problems to an online database that can be accessed by civic authorities and to an online database that can be accessed by citizens. Thus the system can push data or allow a user to pull data as desired. The system can take advantage of UPS enabled devices to automatically obtain more precise geographic and location information than is typically provided by a menu driven operator based system. The system also includes the ability to transmit images of the problem via camera-phone or other web enabled imaging system so that the severity and extent of the problem can be easily determined by remote observation.

The system allows citizens to report infrastructure incidents and problems such as graffiti, trash/sanitation issues, animal control, street maintenance, property issues, abandoned vehicle, and the like, in a geographical area.

Another advantage of the present system is to provide a system, method, apparatus and computer program for collection of submitted reports from mobile devices into a central database maintained on a web server.

### BRIEF DESCRIPTION OF THE DRAWINGS

FIG. 1 illustrates an embodiment of the system.

FIG. 2 illustrates an image capture step of an embodiment of the system.

FIG. 3 illustrates a reporting screen of an embodiment of the system.

FIG. 4 illustrates option presentation in a reporting screen of the system.

FIG. 5 illustrates an comment entry option.

FIG. 6 illustrates a submission page of the system.

FIG. 7 illustrates media packaging and processing in an embodiment of the system.

FIG. 8 is a flow diagram illustrating the operation of the system when a user detects and reports a civic problem.

FIG. 9 is a flow diagram illustrating the operation of the system when the system receives an report of a civic problem.

FIG. 10 is a flow diagram illustrating the operation of a user account when the user is in an alert mode for civic problems.

FIG. 11 is a block diagram of an example computer embodiment for implementing the system.

### DETAILED DESCRIPTION OF THE SYSTEM

The system contemplates an application on a mobile computing device such as a phone, smartphone, PDA, NetBook, Blackberry, iPad, tablet computer, or any other computing device. The mobile application enables users in specific geographic locations to report civic incidents, such as graffiti, trash/sanitation, abandoned vehicles and other sources of blight within their community through the use of the mobile device.

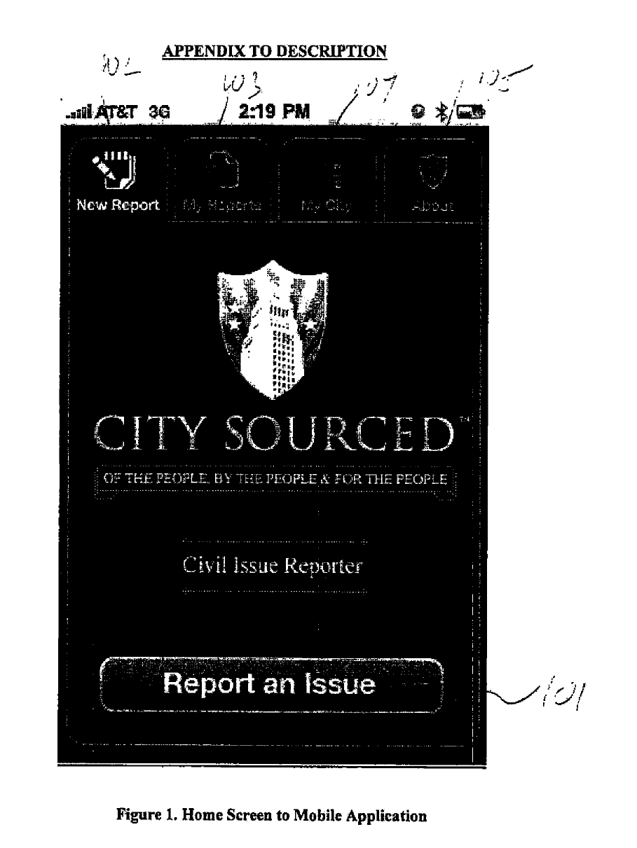

FIG. 1 illustrates an start-up screen in an embodiment of the system. The user accesses the application and is prompted with a menu option 101 on the User Interface to “Report an Issue.” Users can also select one of the options located within a menu bar on the User Interface of “New Report,” 102 “My Reports,” 103 “My City,” 104 and “About” 105. Once the user selects “Report an Issue,” the system takes the user through a number of screens to help guide them through the reporting process. The system also takes advantage of services available to the device to automatically collect information that can be important to the reporting. This automatic information can include date and time, and position and geographic information from a GPS enabled device.

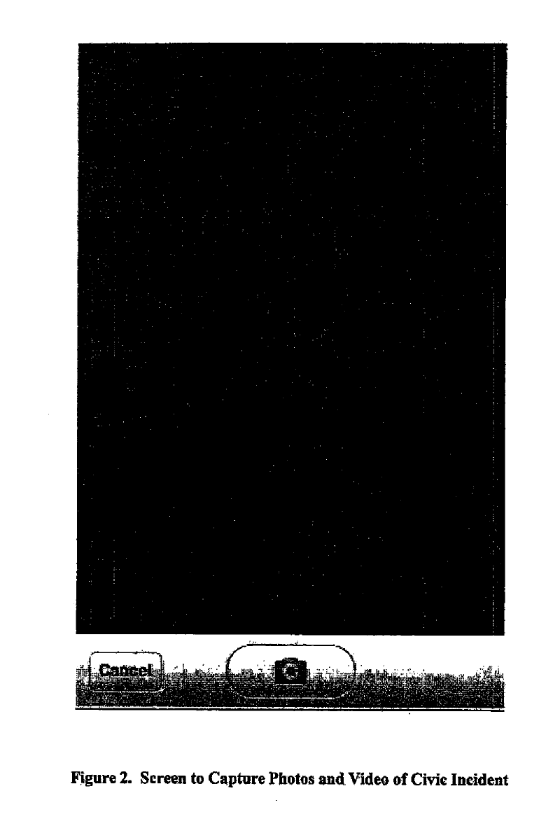

The selection of “Report an Issue” 101 takes the mobile device user to a second screen shown in FIG. 2 where the mobile device user can take a photograph or video with their mobile device, accessing the internal camera feature of the mobile device. After taking the photograph or video, users view a preview of their photograph or video and select a “Use” option if they wish to use the photo or video as part of the report.

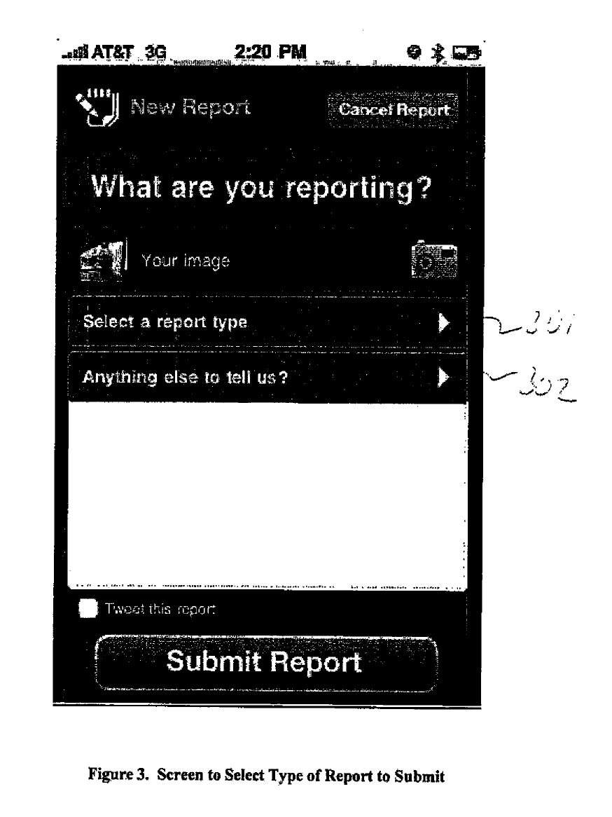

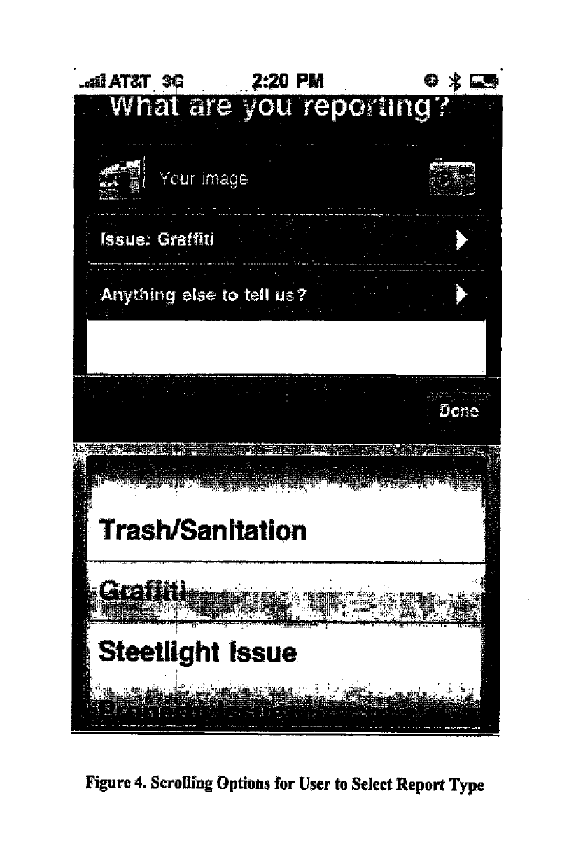

Once the user submits a photo or video, they are taken to another screen as shown in FIG. 3 where they can input further data. The user is asked to “Select a Report Type,” 301 selecting from options such as: graffiti, trash/sanitation, animal control, street maintenance, property issue, or abandoned vehicle, or other issue in a specific geographical area. (Please see FIG. 4 for an example of these options).

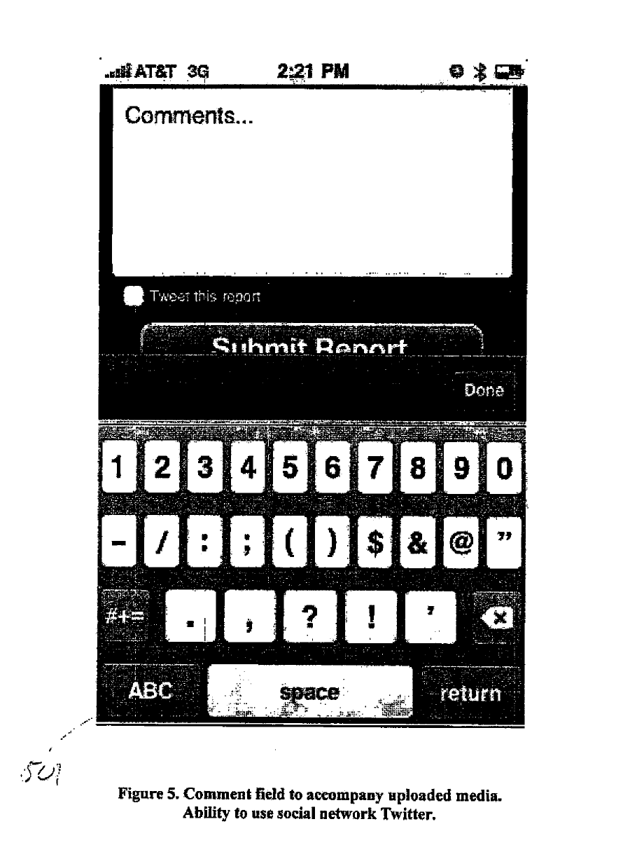

The user is then prompted on the same screen in an open comment field under tab 302 to type additional information into the application to accompany their photograph or video and selection of Report Type. FIG. 5 shows a data input screen for those devices that use touch screens or do not have a separate hardware keyboard. The user can select the type of symbols by cycling through button 501.

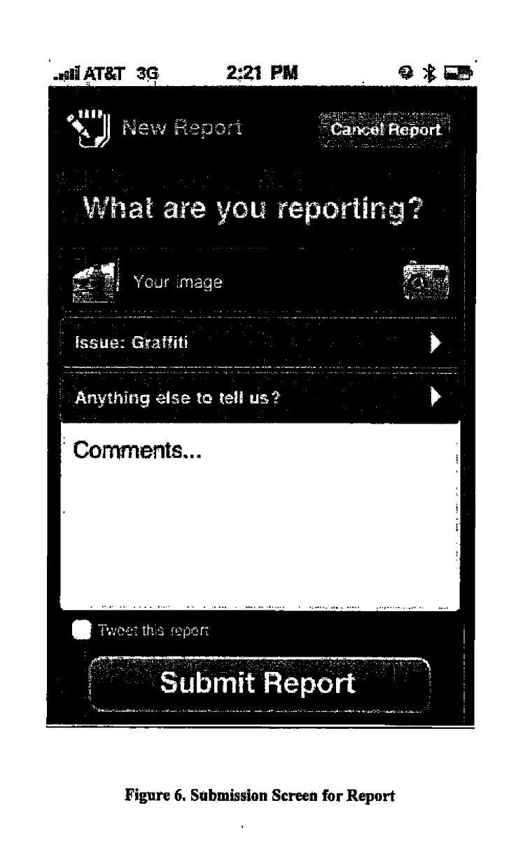

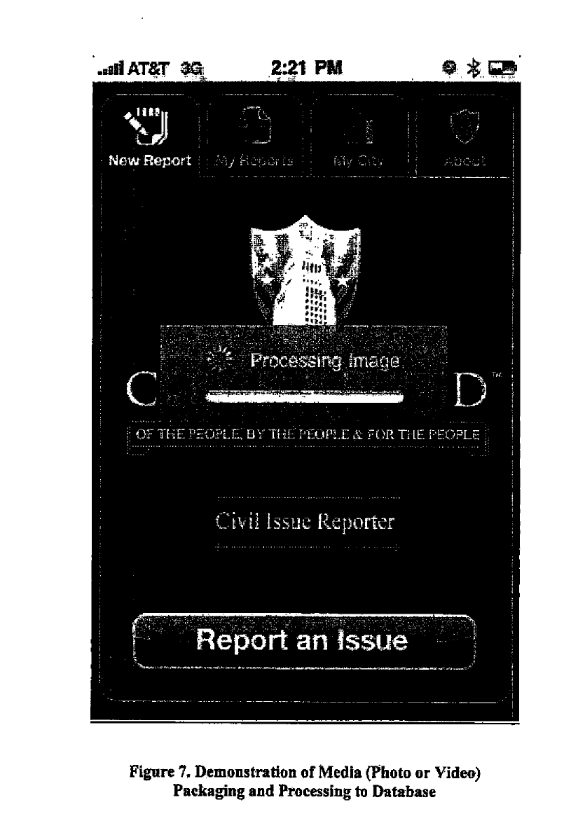

The mobile application then processes the photograph or video that was taken. The photograph or video is encoded, with the direction in which the user was standing, the current Global Positioning System (GPS) coordinates if the mobile device is GPS-enabled, the incident type, and any additional information that the user entered. The information is sent in one data payload to a web server that stores all this information with the corresponding coordinates on a map when the user selects “Submit Report” in FIG. 6. FIG. 7 is an example of the processing of an image in preparing or sending a report.

Once sent the system uses a database of tens of thousands of cities and civic officials to determine the correct destination of the report. For example, a graffiti report in one part of a city will get routed to the correct department and official for that geographic area.

The User Interface includes other options: “My Reports” 103 and “My City” 104.

“MyReport” takes the user to a screen where the user is able to view all reports that they have submitted through the application.

“MyCity” takes users to a screen where the user is able to view all reports that other users in their geographic area have submitted through the mobile application. The application starts by locating the current position of the user, sends it to the web server, finds all matching incidents in a twenty-five to thirty mile radius and reports them to the user. The user is able to see these incidents displayed on a map within the mobile application, with pinpoints of different colors representing their reports and the reports of other users.

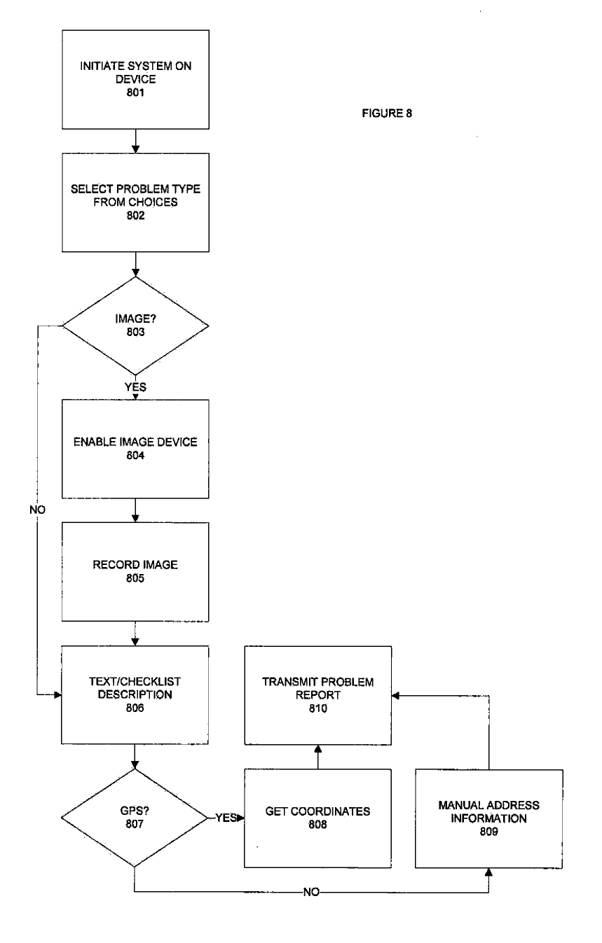

FIG. 8 is a flow diagram illustrating the operation of the system. At step 801 the user initiates the system when a civic problem is encountered and chooses “Report an Issue”. At step 802 the system offers the user an option of which type of problem to report. This may be done via a scrollable menu on the display of the user device.

At step 803 the system determines if the problem to report is one for which an image is appropriate. If so, the system proceeds to step 804 and enables the imaging mode of the users mobile device and, where possible, offers the user the opportunity to select camera or video for recording images. At step 805 the user records the image of the problem (either via one or more still pictures or via video).

At step 806, or if the decision at step 803 was that no image was appropriate, the user is prompted to describe the problem via text entry or via selecting pre-determined descriptions or icons representing the problem. For example, if the problem was a pothole, the user could be prompted to select the lane, direction, and approximate size and depth of the pothole via graphical selectable icons or check lists, or by entering text into a text field.

At step 807, the system determines if the user's device is a GPS enabled device. This may be via a real-time communication with the device, via a question posed to the user as part of the reporting process, or via registration information provided by the user during creation of the user account. If there is GPS capability, the system interrogates the user's device for the GPS coordinate information at step 808. If there is no GPS enablement, the user enters coordinate information as well as possible at step 809, such as via street address, city, and zip.

At step 810, the report is transmitted to the system centralized processing system. It should also be noted that the user may, in some cases, report the problem from another device or desktop computer that is not at the scene of the problem. In that case, the user may upload images and the GPS option will not be available.

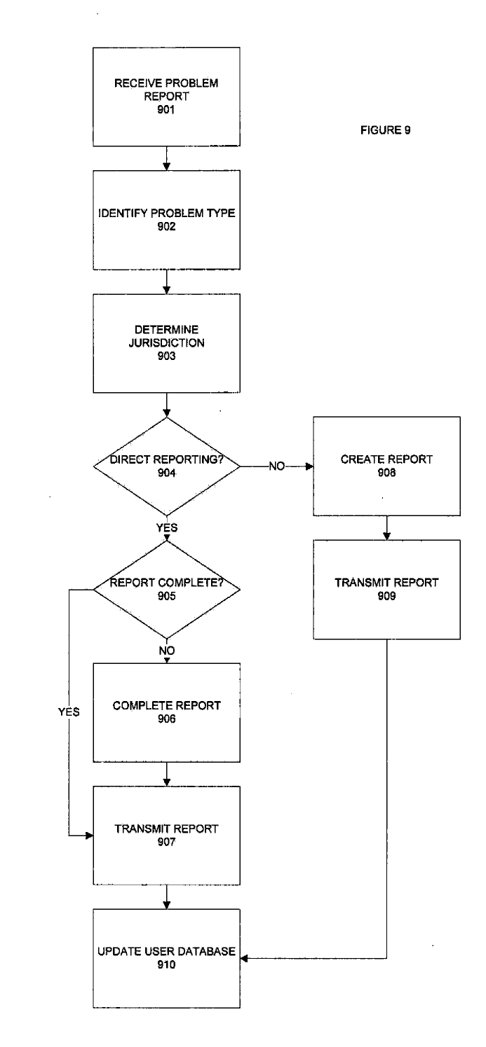

FIG. 9 is a flow diagram illustrating the operation of the system when receiving a report of a civic problem. At step 901 the system receives a problem message from a user. At step 902 the system identifies the type of problem that is being reported. As noted above, such problems include potholes, graffiti, obscured traffic signs, broken or burnt out lights, animal control issues, and the like.

At step 903, the system determines in which jurisdiction the problem is located. In one embodiment, the system has established relationships with civic agencies in which the system can forward problem reports electronically or digitally to the proper agency. At step 894 the system determines if there is a direct reporting relationship with the agency in the jurisdiction of interest. If so, the system checks at decision block 905 to see if the supplied information is complete enough for the reporting requirements of the agency. If not, the system provides any additional information at step 906. If so, the system proceeds to step 907 and transmits the problem report electronically to the appropriate agency.

If there is no direct reporting relationship with the appropriate agency at step 804, the system causes a manual problem report to be prepared at step 908 and transmits the problem report (such as via mail, telephone, or fax) at step 909. At step 910, the system updates the user database so that users of the system can find or be alerted to the civic problem.

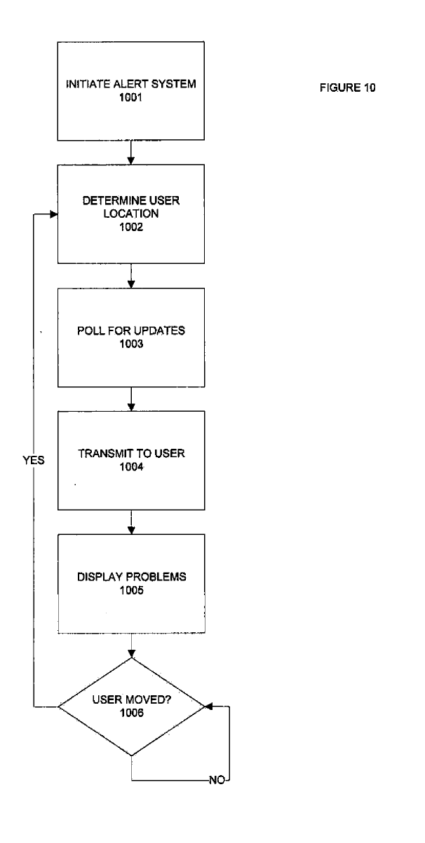

FIG. 10 is a flow diagram illustrating the operation of the system when a user is travelling or moving in a geographic region. At step 1001 the user initiates an alert system on a mobile device. The alert system will let the user know of any reported problems in the geographic region where the user is or is travelling through. At step 1002 the system determines the current location of the user. At step 1003 the system polls the central processing system and requests updates of any reported and unresolved problems in that geographic location. In one embodiment, there is a predefined distance from the user outside of which problems will not be reported.

At step 1004 the system transmits the list or reported problems to the user's device. At step 1005 the problems are reported on the user device. This may include listing them in order of closest first and furthest last. In another embodiment, the system can present the problems on a map with the user at the center and the problems placed accordingly.

At decision block 1006 it is determined if the user has moved. This is accomplished by receiving GPS information from the user's device. If so, the system returns to step 1002 and the system cycles through. If not, the system returns to step 1006.

In an alternate embodiment, the system need not receive GPS information from the user. In this embodiment, the system sends periodic updates to the user in a wide geographic region. The information is stored locally on the user's device. The user's device then tracks its own position with enabled. GPS without reporting the user position to any central processing system. As the device identifies its position, it recalls and displays the problems within range of the user.

In one embodiment of the system, the agency to which a problem is reported provides status and completion updates back to the system, so that reported problems can be cleared from the system. The notification may be via data push, SMS text message, or via some other communication.

### Embodiment of Computer Execution Environment (Hardware)

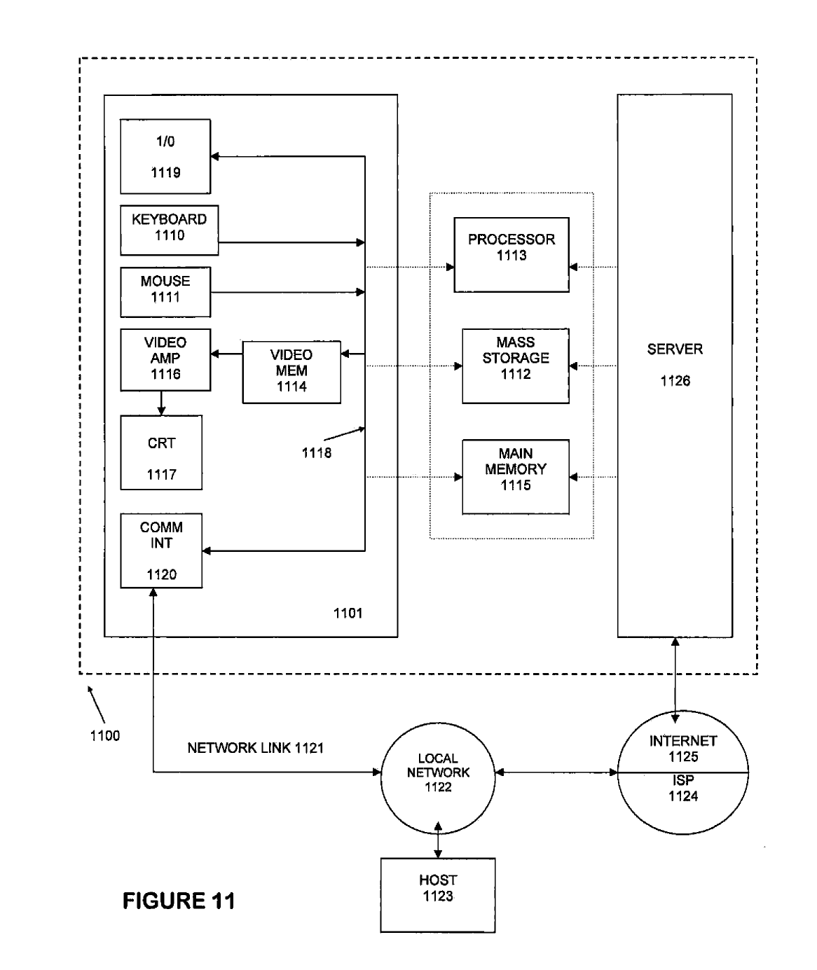

An embodiment of the system can be implemented as computer software in the form of computer readable program code executed in a general purpose computing environment such as environment 1100 illustrated in FIG. 11, or in the form of bytecode class files executable within a Java.™. run time environment running in such an environment, or in the form of bytecodes running on a processor (or devices enabled to process bytecodes) existing in a distributed environment (e.g., one or more processors on a network). A keyboard 1110 and mouse 1111 are coupled to a system bus 1118. The keyboard and mouse are for introducing user input to the computer system and communicating that user input to central processing unit (CPU 1113. Other suitable input devices may be used in addition to, or in place of, the mouse 1111 and keyboard 1110. I/O (input/output) unit 1119 coupled to bi-directional system bus 1118 represents such I/O elements as a printer, A/V (audio/video) I/O, etc.

Computer 1101 may include a communication interface 1120 coupled to bus 1118. Communication interface 1120 provides a two-way data communication coupling via a network link 1121 to a local network 1122. For example, if communication interface 1120 is an integrated services digital network (ISDN) card or a modem, communication interface 1120 provides a data communication connection to the corresponding type of telephone line, which comprises part of network link 1121. If communication interface 1120 is a local area network (LAN) card, communication interface 1120 provides a data communication connection via network link 1121 to a compatible LAN. Wireless links are also possible. In any such implementation, communication interface 1120 sends and receives electrical, electromagnetic or optical signals which carry digital data streams representing various types of information.

Network link 1121 typically provides data communication through one or more networks to other data devices. For example, network link 1121 may provide a connection through local network 1122 to local server computer 1123 or to data equipment operated by ISP 1124. ISP 1124 in turn provides data communication services through the world wide packet data communication network now commonly referred to as the “Internet” 1125 Local network 1122 and Internet 1125 both use electrical, electromagnetic or optical signals which carry digital data streams. The signals through the various networks and the signals on network link 1121 and through communication interface 1120, which carry the digital data to and from computer 1100, are exemplary forms of carrier waves transporting the information.

Processor 1113 may reside wholly on client computer 1101 or wholly on server 1126 or processor 1113 may have its computational power distributed between computer 1101 and server 1126. Server 1126 symbolically is represented in FIG. 11 as one unit, but server 1126 can also be distributed between multiple “tiers”. In one embodiment, server 1126 comprises a middle and back tier where application logic executes in the middle tier and persistent data is obtained in the back tier. In the case where processor 1113 resides wholly on server 1126, the results of the computations performed by processor 1113 are transmitted to computer 1101 via Internet 1125, Internet Service Provider (ISP) 1124, local network 1122 and communication interface 1120. In this way, computer 1101 is able to display the results of the computation to a user in the form of output.

Computer 1101 includes a video memory 1114, main memory 1115 and mass storage 1112, all coupled to bi-directional system bus 1118 along with keyboard 1110, mouse 1111 and processor 1113.

As with processor 1113, in various computing environments, main memory 1115 and mass storage 1112, can reside wholly on server 1126 or computer 1101, or they may be distributed between the two. Examples of systems where processor 1113, main memory 1115, and mass storage 1112 are distributed between computer 1101 and server 1126 include thin-client computing architectures and other personal digital assistants, Internet ready cellular phones and other Internet computing devices, and in platform independent computing environments.

The mass storage 1112 may include both fixed and removable media, such as magnetic, optical or magnetic optical storage systems or any other available mass storage technology. The mass storage may be implemented as a RAID array or any other suitable storage means. Bus 1118 may contain, for example, thirty-two address lines for addressing video memory 1114 or main memory 1115. The system bus 1118 also includes, for example, a 32-bit data bus for transferring data between and among the components, such as processor 1113, main memory 1115, video memory 1114 and mass storage 1112. Alternatively, multiplex data/address lines may be used instead of separate data and address lines.

In one embodiment of the invention, the processor 1113 is a microprocessor such as manufactured by Intel, AMD, Sun, etc. However, any other suitable microprocessor or microcomputer may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the cathode ray tube (CRT) raster monitor 1117. Video amplifier 1116 is well known in the art and may be implemented by any suitable apparatus. This circuitry converts pixel data stored in video memory 1114 to a raster signal suitable for use by monitor 1117. Monitor 1117 is a type of monitor suitable for displaying graphic images.

Computer 1101 can send messages and receive data, including program code, through the network(s), network link 1121, and communication interface 1120. In the Internet example, remote server computer 1126 might transmit a requested code for an application program through Internet 1125, ISP 1124, local network 1122 and communication interface 1120. The received code maybe executed by processor 1113 as it is received, and/or stored in mass storage 1112, or other non-volatile storage for later execution. In this manner, computer 1100 may obtain application code in the form of a carrier wave. Alternatively, remote server computer 1126 may execute applications using processor 1113, and utilize mass storage 1112, and/or video memory 1115. The results of the execution at server 1126 are then transmitted through Internet 1125, ISP 1124, local network 1122 and communication interface 1120. In this example, computer 1101 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for reporting civic incidents via a mobile device comprising:
Initiating a reporting application on a processing device;
Selecting a problem type from a menu of choices;
Selecting descriptors of the problem from a menu of choices;
Transmitting the problem type and descriptors to a central processing system.

2. The method of claim 1 further including identifying the location of the civic incident.

3. The method of claim 2 where identifying the location is performed automatically via geotracking.

4. The method of claim 1 further including the step of recording an image of the civic incident and including it with the report.

5. The method of claim 4 wherein the image is at least one still image.

6. The method of claim 5 wherein the image is a video image.
